(19) United States
(12) Patent Application Publication
(10) Pub. No.: US 2024/0329246 A1
(43) Pub. Date: Oct. 3, 2024

(54) COMMON-PATH HIGH-REPETITION-FREQUENCY LUNAR LASER RANGING SYSTEM AND METHOD

(71) Applicant: Yunnan Observatories, Chinese Academy of Sciences, Kunming (CN)

(72) Inventors: Yuqiang LI, Kunming (CN); Honglin FU, Kunming (CN); Dongsheng ZHAI, Kunming (CN); Zhulian LI, Kunming (CN); Rufeng TANG, Kunming (CN); Haitao ZHANG, Kunming (CN); Xiaoyu PI, Kunming (CN); Rongwang LI, Kunming (CN); Yongzhang YANG, Kunming (CN); Xiaoli SU, Kunming (CN); Lijuan HE, Kunming (CN); Yaoheng XIONG, Kunming (CN)

(21) Appl. No.: 18/128,551

(22) Filed: Mar. 30, 2023

(51) Int. Cl. G01S 17/10; G01S 7/481; G01S 7/52

(52) U.S. Cl. CPC G01S 17/10; G01S 7/4811; G01S 7/52077

(57) ABSTRACT

The present disclosure discloses a common-path high-repetition-frequency lunar laser ranging system and method. In the system, a kHz laser, a beam expanding negative lens, a beam expanding positive lens and a laser docking mirror are sequentially arranged along the optical path direction; the laser beam emitted by the kHz laser enters a telescope through the laser docking mirror after passing through the beam expanding negative lens and the beam expanding positive lens, and then is emitted to a lunar retro-reflector; the beam expanding negative lens and the beam expanding positive lens are arranged in a confocal manner; a beam splitter, a focusing lens, a rotating shutter, an adjustable diaphragm, a collimating lens, an optical filter and a detector are sequentially arranged along the optical path direction; the adjustable diaphragm is installed at the common focus of the focusing lens and the collimating lens.

### TECHNICAL FIELD

The present disclosure relates to the technical field of optics, in particular to a common-path high-repetition-frequency lunar laser ranging system and method.

### BACKGROUND

Because the lunar ranging data can be used to range the geocentric coordinates of world time, polar motion and ground points, and to study the lunar orbit and the internal structure, C. Alley, P. Bender and R. Dickey put forward a groundbreaking idea: placing a laser retro-reflector on the surface of the moon to carry out Lunar Laser Ranging (LLR).

The existing 1.2 m telescope in Yunnan Observatories has an effective clear aperture of 1050 mm. A primary mirror and a secondary mirror are both paraboloids of revolution. The focal length of the primary mirror is 1800 mm, the focal length of the secondary mirror is −240 mm, and the two mirrors are confocal, thus forming an afocal telescope optical system with a focal ratio of 7.5. There are five plane mirrors in the optical path, which reflect the optical path of the telescope off-axis and are connected with the Coude Room. The 1.2 m telescope shown in FIG. 1 comprises: a primary mirror 1, a secondary mirror 2, an off-axis mirror 3, an off-axis mirror 4, an off-axis mirror 5, an off-axis mirror 6, an off-axis mirror 7, an imaging mirror 8 and a camera 9. Traditionally, the common-path laser ranging uses a rotating mirror as a receiving/transmitting path conversion device. For the high-repetition-frequency laser ranging at kHz, due to the limitation of the current rotating mirror technology, the receiving/transmitting path conversion cannot be completed quickly, so that the rotating mirror switching technology cannot meet the high-repetition-frequency laser ranging at kHz.

Therefore, how to overcome the shortcomings of the existing technology is an urgent problem in the technical field of optics.

### SUMMARY

The present disclosure aims to provide a common-path high-repetition-frequency lunar laser ranging system and method, which can improve the accuracy of lunar laser ranging.

In order to achieve the above objective, the present disclosure provides the following scheme.

A common-path high-repetition-frequency lunar laser ranging system is provided, comprising: a laser emitting optical path, a telescope and an echo receiving optical path;
the laser emitting optical path comprises a kHz laser, a beam expanding negative lens, a beam expanding positive lens and a laser docking mirror which are sequentially arranged along the optical path direction; the laser beam emitted by the kHz laser enters the telescope through the laser docking mirror after passing through the beam expanding negative lens and the beam expanding positive lens, and then is emitted to a lunar retro-reflector; the beam expanding negative lens and the beam expanding positive lens are arranged in a confocal manner;
the echo receiving optical path comprises a beam splitter, a focusing lens, a rotating shutter, an adjustable diaphragm, a collimating lens, an optical filter and a detector which are sequentially arranged along the optical path direction; the focusing lens and the collimating lens are a pair of confocal lenses; the adjustable diaphragm is installed at the common focus of the focusing lens and the collimating lens; the echo of the telescope is focused by the focusing lens after being reflected by the beam splitter, filtered by the rotating shutter and the adjustable diaphragm, transformed into an unfocused beam by the collimating lens, and finally filtered by the optical filter, and then enters the detector.

Preferably, the laser beam expanded by the beam expanding negative lens and the beam expanding positive lens has a diameter of 40 mm; and the laser beam emitted to the lunar retro-reflector has a diameter of 300 mm.

Preferably, the aperture of the adjustable diaphragm increases corresponding to the field of view of 3″ to 15″.

Preferably, the optical filter is an ultra-narrow band adjustable constant temperature filter with a bandwidth of 0.2 nm to 0.4 nm.

Preferably, when the kHz laser outputs a wavelength of 532 nm, the detector is an HQE-SPAD single photon detector; and when the kHz laser outputs a wavelength of 1064 nm, the detector is a 2*2 superconducting array detector.

Preferably, the common-path high-repetition-frequency lunar laser ranging system further comprises: an event timer;
wherein the event timer is configured to measure the time when an event occurs.

Preferably, the event timer comprises a dual-channel event timer or a multi-channel event timer.

A common-path high-repetition-frequency lunar laser ranging method using the common-path high-repetition-frequency lunar laser ranging system is provided, wherein the ranging method comprises:
using a telescope to track a lunar retro-reflector;
emitting, by a kHz laser, a laser beam to the moon through a beam expanding negative lens, a beam expanding positive lens, a laser docking mirror and a telescope;
triggering, by the laser beam output by the kHz laser, a detector to generate a transmit wave signal and send the transmit wave signal to the event timer to determine the transmit wave time;
reflecting, by the lunar retro-reflector, the laser beam back to the telescope;
receiving, by the telescope, the echo reflected by the lunar retro-reflector, wherein the echo is focused by a focusing lens after being reflected by a beam splitter, filtered by the rotating shutter and the adjustable diaphragm, transformed into an unfocused beam by the collimating lens, and finally filtered by the optical filter, and then enters the detector;
sending the echo signal generated by the detector to an event timer;
determining the distance of the lunar retro-reflector according to the time difference between the arrival time of the echo recorded by the event timer and the transmit wave time.

According to the common-path high-repetition-frequency lunar laser ranging system and method provided by the present disclosure, a laser transmitting optical path and an echo receiving optical path use a method of sharing a telescope and transmitting and receiving in different apertures. A rotating mirror is not used any more, thus avoiding the problem that the rotating speed of the rotating mirror limits the improvement of the laser ranging repetition frequency. Furthermore, the accuracy of lunar laser ranging is improved.

### BRIEF DESCRIPTION OF THE DRAWINGS

FIG. 1 is a schematic diagram of an optical path of a 1.2 m telescope.

FIG. 2 is a schematic diagram of an optical path of a common-path high-repetition-frequency lunar laser ranging system according to the present disclosure.

FIG. 3 is a front view of a turntable of a rotating shutter.

FIG. 4 is a side view of a rotating shutter.

FIG. 5 is a schematic diagram of the control structure of an adjustable diaphragm.

FIG. 6 is a flowchart of a common-path high-repetition-frequency lunar laser ranging method according to the present disclosure.

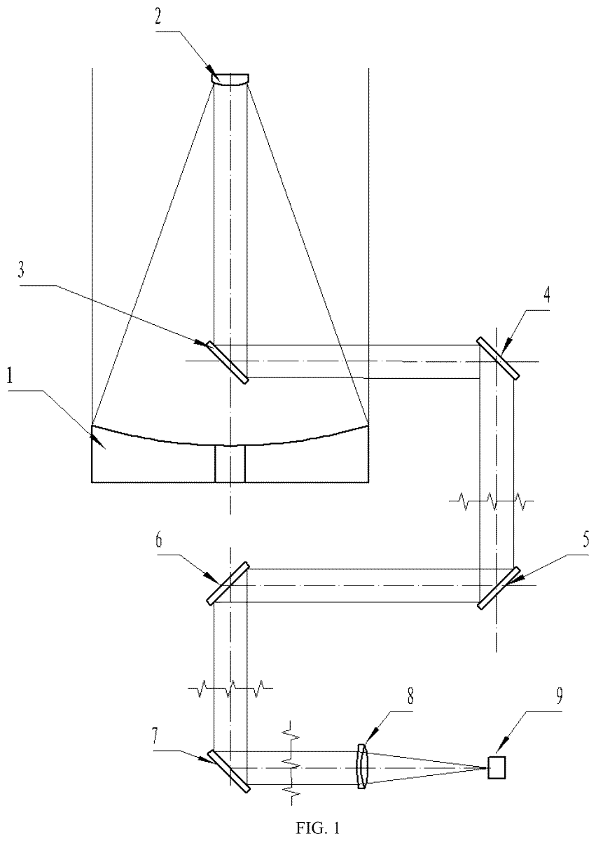

### DETAILED DESCRIPTION OF THE EMBODIMENTS

The present disclosure aims to provide a common-path high-repetition-frequency lunar laser ranging system and method, which can improve the accuracy of lunar laser ranging.

In order to make the above objects, features and advantages of the present disclosure more obvious and understandable, the present disclosure will be further described in detail with the attached drawings and the detailed description.

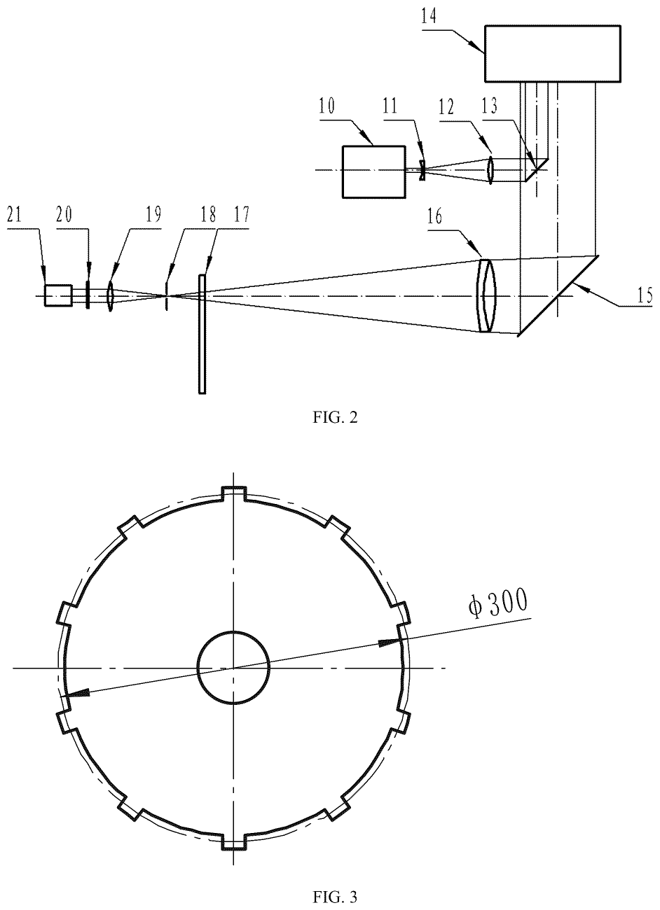

As shown in FIG. 2, a common-path high-repetition-frequency lunar laser ranging system provided by the present disclosure comprises a laser emitting optical path, a telescope 14 and an echo receiving optical path.

The laser emitting optical path comprises a kHz laser 10, a beam expanding negative lens 11, a beam expanding positive lens 12 and a laser docking mirror 13 which are sequentially arranged along the optical path direction; the laser beam emitted by the kHz laser 10 enters the telescope 14 through the laser docking mirror 13 after passing through the beam expanding negative lens 11 and the beam expanding positive lens 12, and then is emitted to a lunar retro-reflector; and the beam expanding negative lens 11 and the beam expanding positive lens 12 are arranged in a confocal manner.

The echo receiving optical path comprises a beam splitter 15, a focusing lens 16, a rotating shutter 17, an adjustable diaphragm 18, a collimating lens 19, an optical filter 20 and a detector 21 which are sequentially arranged along the optical path direction; the focusing lens and the collimating lens 19 are a pair of confocal lenses; the adjustable diaphragm 18 is installed at the common focus of the focusing lens and the collimating lens 19; and the echo of the telescope 14 is focused by the focusing lens 16 after being reflected by the beam splitter 15, filtered by the rotating shutter 17 and the adjustable diaphragm 18, transformed into an unfocused beam by the collimating lens 19, and finally filtered by the optical filter 20, and then enters the detector 21. The focusing lens 16 focuses the echo from the telescope 14, and the aperture diaphragm at the focus filters out the noise different from the echo direction; the collimator lens 19 transforms the echo into a light beam suitable for reception by the detector 21; the rotating shutter 17 filters out the backscattering noise at the time of laser emission. The diameter of the reflector is 40 mm, which blocks part of the echo light. The energy loss is less than 10%, which has little influence on reception.

The laser beam expanded by the beam expanding negative lens 11 and the beam expanding positive lens 12 has a diameter of 40 mm; and the laser beam emitted to the lunar retro-reflector has a diameter of 300 mm.

When the kHz laser 10 outputs a wavelength of 532 nm, the detector 21 is an HQE-SPAD single photon detector 21; and when the kHz laser 10 outputs a wavelength of 1064 nm, the detector is a 2*2 superconducting array detector.

During lunar laser ranging, strong laser scattering and lunar background noise photons greatly increase the difficulty of echo detection. It is proposed to filter the noise in manners of the rotating shutter 17 filtering, spatial filtering, spectral filtering and time filtering. The optical filtering optical path is shown in FIG. 2.

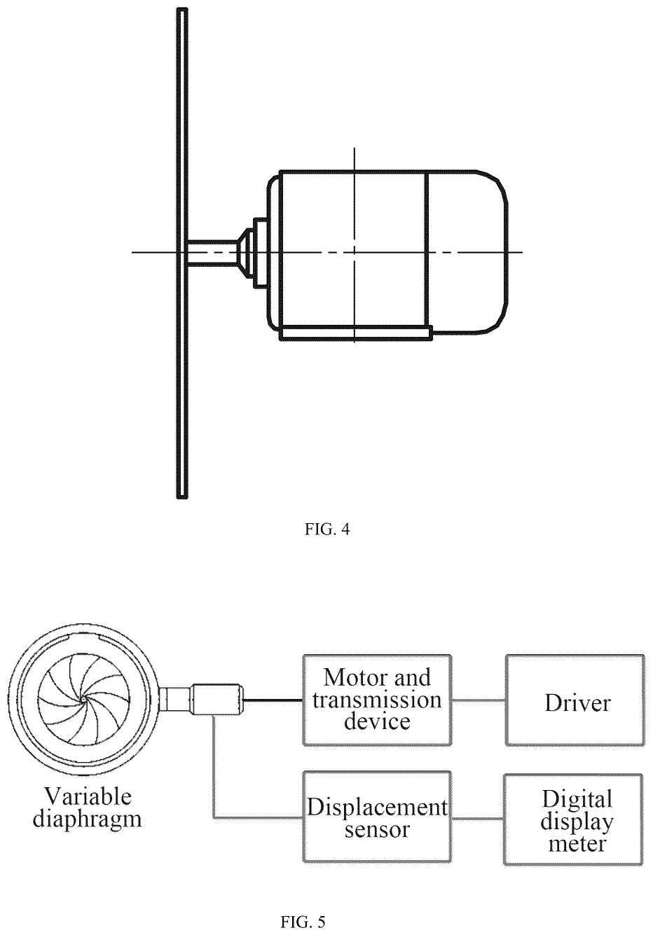

The mechanical structure of the rotating shutter 17 is shown in FIG. 3 and FIG. 4. FIG. 3 is a turntable of the rotating shutter 17. The edge of the turntable is provided with small teeth evenly distributed, and the turntable is connected with a motor to rotate at a high speed. The small teeth of the rotating shutter 17 are installed in the optical path near the common focus of two lenses. A group of photoelectric probes detect the position of the small teeth to generate a master control signal, and the computer issues a laser emission instruction according to the master control signal, so that the small teeth are in the optical path at the laser emission time, blocking the scattered light in the room and the atmospheric backscattered light and protecting the detector 21. When the echo arrives, the small teeth have moved out of the optical path, and the echo can enter the detector 21. The shutter control circuit selects the shutter speed in a certain range according to the range gate signal to realize the shutter function. At the same time, the overlap between the echo arrival time and the laser emission time is avoided. The spatial filtering method is as follows: installing a field diaphragm at the focusing point of the echo beam can filter out noise photons different from the echo direction. The present disclosure uses an electrically adjustable diaphragm 18, and adapts to different background noises in the manner of controlling the change of the field diaphragm. The aperture of the diaphragm increases corresponding to the field of view of 3″ to 15″.

Spectral filtering uses the characteristics that the sky noise has a wide spectrum and a single laser wavelength, and uses an ultra-narrow band spectral filter 20 in the echo receiving system to effectively suppress the interference of the background noise. In the present disclosure, an ultra-narrow band filter 20 with a bandwidth of 0.2 nm to 0.4 nm is provided in front of the detector 21 to filter out noise photons drastically. Temperature has an important influence on the center wavelength of the ultra-narrow band interference filter 20, and the center wavelength will drift with the use time. To this end, a thermostat is used to control the temperature of the optical filter 20. Considering the importance of the use environment, the central wavelength of the narrow-band filter 20 is changed by changing the temperature of the thermostat, so as to effectively match the spectrum and maximize the transmittance of the central wavelength.

The range gate time filtering is a unique filtering method for laser ranging. That is, according to the target orbit prediction data, the data reception is controlled by the range gate technology when the expected echo is arriving, thus greatly reducing the false alarm probability. The orbit prediction of lunar laser ranging is relatively accurate, and the range prediction can be up to 10 m to 20 m (the corresponding time is about 66 ns to 132 ns), so that the scope of the range gate can be set within 2 μs.

Spatial filtering is to provide a pair of confocal lenses in the optical path. The adjustable diaphragm 18 is installed at the common focus. The size of the receiving field of view is determined by the aperture size of the diaphragm. As shown in FIG. 5, the electromechanical structure of the adjustable diaphragm 18 is driven by a motor, ranged by a sensor in real time, and provided with limit protection devices at both ends to prevent the diaphragm from being damaged due to over-range use.

The minimum aperture of the diaphragm is 0.5 mm and the maximum aperture is 5 mm. The aperture of the diaphragm can be continuously adjusted within the above range. According to the noise level of the detector 21, the receiving field of view is adjusted in real time to adapt to the ranging demand under different noises.

The laser in lunar laser ranging is a key component in the system. The high-repetition-frequency kHz laser 10 is pumped by a semiconductor, which can generate a stable 1 kHz laser signal as the laser light source of the KHz laser ranging. Moreover, the laser energy of a single pulse is small, so that the damage to the laser itself and the optical system is less after operating for a long time, and the reliability and the service life of the laser are improved. In addition, with the increase of the laser frequency, the number of LLR echo points will be greatly increased, and the ability to quickly capture targets will also be improved.

The main technical parameters of the kHz laser 10 are as follows:
a) operating wavelength: 1064 nm/532 nm, in which the wavelength can be switchable and output simultaneously;
b) average power: ≥30 W@1064 nm@1000 Hz, ≥15 w@532 nm@ 1000 hz;
c) pulse width: ≤40 ps;
d) operating frequency: 975 Hz to 1000 Hz, in which an external trigger function is provided;
e) beam quality: M2≤2;
f) spot diameter: ≤7 mm (light outlet).

The laser in the present disclosure can output two wavelengths. The detection of the laser with the corresponding wavelength of 532 nm uses the HQE-SPAD single photon detector 21 (the target surface of the detector 21 is 0.5 mm, the detection efficiency is 60%, and the time resolution is 35 ps) as an echo receiving device, while the laser with the wavelength of 1064 nm uses the 2*2 superconducting array detector 21 (the fiber diameter is 0.2 mm, the detection efficiency is 30%, and the time resolution is 50 ps) as an echo receiving device.

In the kHz lunar laser ranging system, the event timer is one of the necessary devices in the timing system. The event timer is a computer-based device for accurately measuring the event time (input pulse), which is used to range the transmit wave signal and the echo signal of the laser in the lunar laser ranging. Because the device measures the time when an event occurs, the transmit wave and the echo of the laser are regarded as independent events. The event time can be accurately recorded when the event arrives, which can improve the ranging frequency of laser ranging. The present disclosure plans to adopt a dual-channel event timer A033-ET and a multi-channel event timer produced by GuideTech Company.

If the target can be imaged in lunar laser ranging, the success rate of ranging will be greatly improved, so that the target monitoring system needs to be reformed. The beam received by the telescope 14 is focused by an imaging mirror. The beam is reflected by a switchable mirror and is transformed into an unfocused beam by the combined lens, and then is imaged on an CMOS camera by the focusing lens 16.

The imaging optical path is jointly designed with the optical paths of the telescope 14 of 1.2 m. The imaging mirror consists of two lenses. As far as the imaging mirror is concerned, most of the primary aberrations, including spherical aberration and chromatic aberration, are eliminated, and the image quality is good, in which the image quality of the central part is better than 0.5 times the diffraction limit, and the image quality of the edge part is better than 0.2 times the diffraction limit. After the switchable mirror moves out of the optical path, the common CCD can receive the image of the telescope 14 with good image quality.

When the switchable mirror is in the optical path, the subsequent combination lens converts the light into an unfocused beam for placing the negative optical filter 20, and the focusing lens 16 focuses the unfocused beam on the CMOS camera. The latter two groups of lenses are also designed in conjunction with the optical path of the telescope 14, and most of the primary aberrations are finally eliminated. The image quality of the central part is better than 0.3 times the diffraction limit, and the image quality of the edge part is better than 0.1 times the diffraction limit.

The control system of kHz lunar laser ranging is the link and the control center connecting all parts of the LLR, which controls emitting the laser, turning on the receiver and operating the servo system according to the strict time sequence. At the same time, the control system also receives information from each subsystem (the event timer, the meteorological device) in real time, carries out relevant processing and displays images, and also provides a human-computer interaction interface. The difficulties are as follows. 1) The receiver is turned on, that is, the range gating technology is used to avoid noise interference. This part has the highest real-time performance and is very critical. 2) The event timer only records the echo time corresponding to the transmit wave, which needs to be converted into the target distance by the transmit-echo matching algorithm. 3) The noise of the kHz laser ranging is large, and it is necessary to use a real-time filtering technology to extract signal points so that observers can judge whether the ranging is effective or not.

The LLR widely uses the range gating technology (time filtering) to prevent noise interference. The higher the accuracy of range gating, the higher the probability of echo detection. The circuit provides an accurate gating signal for lunar laser ranging and generates a signal to control the rotating speed of the rotating shutter 17. In the actual ranging process, the thermal noise and the sky background noise of a photoelectric receiving device will cause false triggering to a photon detecting device, resulting in abnormal values in LLR. Therefore, before the actual application of data, data preprocessing must be carried out, including eliminating abnormal values, evaluating data quality and deducting various systematic errors.

The increase of the ranging frequency places high demands on the real-time performance and the speed of the ranging control system. A scheme is proposed to realize the ranging control system of kHz lunar laser ranging under the windows operating system, as shown in FIG. 5.

In order to meet the real-time performance and speed requirements of kHz lunar laser ranging, this design allocates the works of LLR control on two computers. Computer A is responsible for the servo tracking control of the telescope 14, including the tracking control interface and the fine-tuning search interface. Computer B is responsible for the LLR control system, receiving the synchronous signal of the rotating mirror, sending the laser emission command, sending the gating signal, sending the shutter opening signal and collecting the meteorological parameter data. At the same time, computer B is also responsible for receiving the echo events of the transmit wave and pairing the echo events, displaying the residual, displaying the histogram of the residual statistics and extracting the real-time signals. Real-time performance analysis shows that the part with the highest real-time performance of the kHz LLR control system is the transmission of range gating. Considering that the laser pulse jitter of the kHz laser 10 is small, the output time of each gating can be predicted accurately in advance, and the output time of the gating can be put into the FIFO of the range gating circuit in advance, so as to reduce the real-time performance requirements for the ranging control software.

The event timer can accurately record the time (or referred to as epoch) of each event. According to the round-trip time interval of the laser pulse calculated by the predicted orbit of the lunar retro-reflector, the ranging control software can identify the respective time of the relevant transmit waves and the echoes, and the time difference is the distance from the lunar retro-reflector to the LLR station.

The transmit-echo correspondence algorithm defines two arrays, in which an array is used to store the transmit wave time, and the other array is used to store the echo time. The event times measured by the event timer are stored in the corresponding arrays in sequence. Every time we retrieve the wave arrays, the earliest wave array corresponds to all the transmit waves. Once there is a successful match, that is, the difference between the interval between the transmit wave and the echo and the predicted value of the satellite distance is less than a limited value, the laser flight time is calculated, and the pointers of the transmit-echo array move forward. If the echo has no matching transmit wave, the echo is deleted.

In order to obtain the synchronization time with the GPS, the control system uses a counter board with 10 MHz as the clock and 1 pps as the counting starting point for maintenance. The circuit contains a lot of numerical calculation and data transmission work. An FPGA (Field Programmable Gate Array) from ALTERA Company is chosen as the digital circuit development device of the generator, which not only saves PCB area, but also improves the stability of the whole circuit system and is beneficial to the update of system functions.

Combining the parameters of the ranging system of the 1.2 m telescope 14 of Yunnan Observatories and the meteorological conditions of the station site, and comprehensively considering the tracking accuracy of the telescope 14, the atmospheric seeing and other factors, the feasibility of detecting the lunar retro-reflector with the 1.2 m laser ranging system is systematically analyzed. The average photoelectron number Is detected in the laser ranging system and the ranging success rate ζ (Poisson distribution) are estimated (refer to J. Degnan's ppt at the SLR School in Germany in 2019):

nₛ=Eₜ/ℏc/ληₜ2/π(θ_{d}R)² exp[−2(Δθₚ/θ_{d})²][1/1+(Δθⱼ/θ_{d})²](σAᵣ/4πR²)ηᵣη_{c}Tₐ²T_{c}²;

ζ=1−p(0; nₛ)=1−e^{-N}^{ₛ};

where Eₜ is the laser single pulse energy, λ is the laser wavelength, ℏ is the Planck constant (6.626196E-34), c is the speed of light in vacuum (299792458 m/s), θ_{d}, Δθₚ, Δθⱼ are the half angle of the divergence angle, the pointing deviation and the tracking jitter RMS of the Gaussian beam, respectively, σ is the optical scattering cross section of the target, R is the distance from the LLR station to the target, Aᵣ is the receiving area of the receiving telescope 14, ηₜ, ηᵣ, η_{c} are the optical efficiency of the transmitting system, the optical efficiency of the receiving system and the detection efficiency of the detector 21, respectively, and Tₐ and T_{c} are the one-way atmospheric transmission efficiency (transmittance) and the one-way cirrus cloud transmission efficiency (transmittance). It can be seen from the formula that the echo photon number is sensitive to the divergence angle θ_{d} and the pointing deviation Δθₚ.

### For an Ideal Corner Reflector:

σ_{cc}=ρA_{cc}(4π/Ω)=π^{B}ρD⁴/4λ²;

according to the above formula of the echo photoelectron number, one of the main factors that restrict the realization of lunar laser ranging and affect the ranging accuracy is the number of photons reflected by the corner reflector on the lunar surface and received by the ground. Under the same conditions such as receiving apertures and beam divergence angles, the number of photons received per unit time has a great relationship with laser energy and repetition frequency. In order to realize the lunar laser ranging and obtain enough echo photons, a laser light source with high-repetition-frequency, large energy and small beam divergence angle is needed. At the same time, because the analysis of lunar data requires high ranging accuracy, and the data with low accuracy is of little significance for later analysis and research, the pulse width of the laser light source should be as narrow as possible to achieve high ranging accuracy.

According to the ranging analysis of the lunar retro-reflector Apollo15, there are 300 TIR corner reflectors, D=38 mm. The reflectivity is ρ=0.93, R=384000 km, ηₜ=0.6, ηᵣ=0.3, η_{c}=0.3, T_{c}=1.0 (without considering cirrus clouds). If the laser wavelength is λ=1064 nm:T_{α}=0.8, Eₜ=30 mJ, σ_{A18,cc}=300*0.5*σ_{cc}=5.8e+5.8 m²@1064 nm, it is equivalent to the divergence angle 7.35″ of the corner reflector.

In the ideal case, θ_{d}=1″, Δθₚ=0″, Δθⱼ=0″, the average number of the photoelectrons is 0.890030, and the probability of successful ranging is 58.9357%.

Considering that the reflectivity of Apollo15 corner reflector is reduced to 0.6 originally, that is, ρ=0.6*0.93=0.558, the average number of the photoelectrons is 0.534018, and the detection success probability is 41.3755%.

Considering the tracking jitter (including the atmospheric jitter effect) and the pointing error: Δθₚ=0.5″ and Δθⱼ=1.0″, the average number of the photoelectrons is 0.161949, and the detection success probability is 14.9516%. If the laser wavelength is λ=532 nm, Tₐ=0.6, Eₜ=15 mJ, σ_{A15,cc}=300*0.5*σ_{cc}=5.3e+07 m²@532 nm, it is equivalent to the divergence angle 3.68″ of the corner reflector.

In the ideal case, θ_{d}=1″, Δθₚ=0″, Δθj=0″, the average number of the photoelectrons is 0.500642, and the detection success probability is 39.3859%.

Considering that the reflectivity of Apollo15 corner reflector is reduced to 0.6 originally, that is, σ=0.6*0.93=0.558, the average number of the photoelectrons is 0.300385, and the detection success probability is 25.9467%. Considering the tracking jitter (including the atmospheric jitter effect) and the pointing error: Δθₚ=0.5″ and Δθⱼ=1.0″, the average number of the photoelectrons is 0.091096, and the detection success probability is 8.7070%.

TABLE 1
Estimation results of the number of ranging echo
photons of the lunar retro-reflector Apollo15

| | | | single average | single | average number |
|---|---|---|---|---|---|
| Laser | | average | number of | ranging | of echo points |
| wavelength | | power | photoelectrons | success rate | per second |
| 532 | nm | 15 W | 0.091 | 8.71% | 87 |
| 1064 | nm | 30 W | 0.162 | 14.95% | 149 |

As a comparison, the ranging ability of several conventional LLR stations in the world (the target is Apollo15) is estimated, as shown in Table 1 and Table 2. The related parameters of the LLR station are the aperture of the telescope 14, the optical efficiency of the transmitting system, the optical efficiency of the receiving system, the laser divergence angle (full angle), the quantum efficiency of the detector 21, and the atmospheric transmittance, all of which are taken as 0.6. The parameters are based on the values in the ranged normal point file of Apollo15 and refer to the site log of the ILRS website. APPLO LLR station adopts an array detector 21, and performs estimation by a unit detector 21. The estimated value is actually higher than the following calculated value.

TABLE 2
Comparison results of the values estimated by other LLR stations

| | | | | single | single | average |
|---|---|---|---|---|---|---|
| | | | | average | ranging | number of |
| LLR station and its | laser | Repetition | | number of | success | echo points |
| related parameters | energy | frequency | | photoelectrons | rate | per second |
| Grasse (1.54 m; 0.74; 0.4; | 240 mJ | 10 | Hz | 1.09 | 66.38% | 6.6 |
| 1064 nm; 150 ps; 2″; | | | | | | |
| 20%(SPAD)) | | | | | | |
| MATM (1.50 m; 0.75; | 100 mJ | 10 | Hz | 0.81 | 55.42% | 5.5 |
| 0.44; 532 nm; 40 ps; 2″; | | | | | | |
| 10%(MCP)) | | | | | | |
| APOLLO (3.5 m; 0.6; 0.4; | 115 mJ | 20 | Hz | 3.94 | 98.06% | 19.6 |
| 1″; 30%) | | | | | | |
| Zhuhai (1.20 m; 0.64; | 225 mJ | 100 | Hz | 1.68 | 81.45% | 81.5 |
| 0.28; 1064 nm; 150 ps; 2″; | (blocked by | | | | | |
| 30%(SSPD)) | a 300 mJ | | | | | |
| | secondary | | | | | |
| | mirror) | | | | | |

Through the above estimation and comparison, it is concluded that the single ranging success rate of the common-path high-repetition-frequency (kHz) ranging system is slightly lower, but the repetition frequency is 10 to 100 times that of the above two LLR stations, and the average number of echo points per second are higher than those of other LLR stations. Through theoretical calculation, it can also be seen that it is more conducive to echo recognition to adopt the high-repetition-frequency lunar laser ranging mode. This is also one of the reasons that the satellite laser ranging technology develops towards high-repetition-frequency.

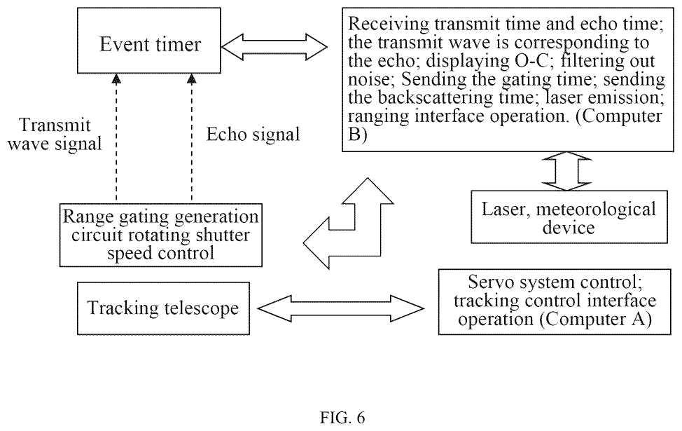

As shown in FIG. 6, the common-path high-repetition-frequency lunar laser ranging method provided by the present disclosure uses the common-path high-repetition-frequency lunar laser ranging system, wherein the ranging method comprises:
using a telescope 14 to track a lunar retro-reflector;
emitting, by a kHz laser 10, a laser beam to the moon through a beam expanding negative lens 11, a beam expanding positive lens 12, a laser docking mirror 13 and a telescope 14;
triggering, by the laser beam output by the kHz laser 10, a detector 21 to generate a transmit wave signal and send the transmit wave signal to the event timer to determine the transmit wave time;
reflecting, by the lunar retro-reflector, the laser beam back to the telescope 14;
receiving, by the telescope 14, the echo reflected by the lunar retro-reflector, wherein the echo is focused by a focusing lens 16 after being reflected by a beam splitter 15, filtered by the rotating shutter 17 and the adjustable diaphragm 18, transformed into an unfocused beam by the collimating lens 19, and finally filtered by the optical filter 20, and then enters the detector 21;
sending the echo signal generated by the detector 21 to an event timer;
determining the distance of the lunar retro-reflector according to the time difference between the arrival time of the echo recorded by the event timer and the transmit wave time.

What is claimed is:

1. A common-path high-repetition-frequency lunar laser ranging system, comprising: a laser emitting optical path, a telescope and an echo receiving optical path;
the laser emitting optical path comprises a kHz laser, a beam expanding negative lens, a beam expanding positive lens and a laser docking mirror which are sequentially arranged along the optical path direction; the laser beam emitted by the kHz laser enters the telescope through the laser docking mirror after passing through the beam expanding negative lens and the beam expanding positive lens, and then is emitted to a lunar retro-reflector; the beam expanding negative lens and the beam expanding positive lens are arranged in a confocal manner;
the echo receiving optical path comprises a beam splitter, a focusing lens, a rotating shutter, an adjustable diaphragm, a collimating lens, an optical filter and a detector which are sequentially arranged along the optical path direction; the focusing lens and the collimating lens are a pair of confocal lenses; the adjustable diaphragm is installed at the common focus of the focusing lens and the collimating lens; the echo of the telescope is focused by the focusing lens after being reflected by the beam splitter, filtered by the rotating shutter and the adjustable diaphragm, transformed into an unfocused beam by the collimating lens, and finally filtered by the optical filter, and then enters the detector.

2. The common-path high-repetition-frequency lunar laser ranging system according to claim 1, wherein the laser beam expanded by the beam expanding negative lens and the beam expanding positive lens has a diameter of 40 mm; and the laser beam emitted to the lunar retro-reflector has a diameter of 300 mm.

3. The common-path high-repetition-frequency lunar laser ranging system according to claim 1, wherein the aperture of the adjustable diaphragm increases corresponding to the field of view of 3″ to 15″.

4. The common-path high-repetition-frequency lunar laser ranging system according to claim 1, wherein the optical filter is an ultra-narrow band adjustable constant temperature filter with a bandwidth of 0.2 nm to 0.4 nm.

5. The common-path high-repetition-frequency lunar laser ranging system according to claim 1, wherein when the kHz laser outputs a wavelength of 532 nm, the detector is an HQE-SPAD single photon detector; and when the kHz laser outputs a wavelength of 1064 nm, the detector is a 2*2 superconducting array detector.

6. The common-path high-repetition-frequency lunar laser ranging system according to claim 1, further comprising: an event timer;
wherein the event timer is configured to range the time when an event occurs.

7. The common-path high-repetition-frequency lunar laser ranging system according to claim 6, wherein the event timer comprises a dual-channel event timer or a multi-channel event timer.

8. A common-path high-repetition-frequency lunar laser ranging method using the common-path high-repetition-frequency lunar laser ranging system according to claim 1, wherein the ranging method comprises:
using a telescope to track a lunar retro-reflector;
emitting, by a kHz laser, a laser beam to the moon through a beam expanding negative lens, a beam expanding positive lens, a laser docking mirror and a telescope;
triggering, by the laser beam output by the kHz laser, a detector to generate a transmit wave signal and send the transmit wave signal to the event timer to determine the transmit wave time;
reflecting, by the lunar retro-reflector, the laser beam back to the telescope;
receiving, by the telescope, the echo reflected by the lunar retro-reflector, wherein the echo is focused by a focusing lens after being reflected by a beam splitter, filtered by the rotating shutter and the adjustable diaphragm, transformed into an unfocused beam by the collimating lens, and finally filtered by the optical filter, and then enters the detector;
sending the echo signal generated by the detector to an event timer;
determining the distance of the lunar retro-reflector according to the time difference between the arrival time of the echo recorded by the event timer and the transmit wave time.

9. The method according to claim 8, wherein the laser beam expanded by the beam expanding negative lens and the beam expanding positive lens has a diameter of 40 mm; and the laser beam emitted to the lunar retro-reflector has a diameter of 300 mm.

10. The method according to claim 8, wherein the aperture of the adjustable diaphragm increases corresponding to the field of view of 3″ to 15″.

11. The method according to claim 8, wherein the optical filter is an ultra-narrow band adjustable constant temperature filter with a bandwidth of 0.2 nm to 0.4 nm.

12. The method according to claim 8, wherein when the kHz laser outputs a wavelength of 532 nm, the detector is an HQE-SPAD single photon detector; and when the kHz laser outputs a wavelength of 1064 nm, the detector is a 2*2 superconducting array detector.

13. The method according to claim 8, further comprising: an event timer,
wherein the event timer is configured to measure the time when an event occurs.

14. The method according to claim 13, wherein the event timer comprises a dual-channel event timer or a multi-channel event timer.
